(19) United States
(12) Patent Application Publication
(10) Pub. No.: US 2024/0028409 A1
(43) Pub. Date: Jan. 25, 2024

(54) DECENTRALIZED COMPUTE INFRASTRUCTURE

(71) Applicant: Intel Corporation, Santa Clara, CA (US)

(72) Inventors: Muthaiah Venkatachalam, Beaverton, OR (US); Gautam Singh, Morrisville, NC (US); Geoffrey Gustafson, Saint Johns, FL (US)

(73) Assignee: Intel Corporation, Santa Clara, CA (US)

(21) Appl. No.: 18/477,660

(22) Filed: Sep. 29, 2023

(51) Int. Cl. G06F 9/50

(52) U.S. Cl. CPC G06F 9/505; G06F 9/5072; G06F 9/5044

(57) ABSTRACT

Embodiments described herein are generally directed to decentralized compute infrastructure (DCI). According to one embodiment, a determination is made by a recommendation engine running on a client computer system to offload a particular non-containerized workload associated with a host application from a SaaS cloud to the client computing system on which the host application is also running. After the determination, a unit of execution in which the particular workload is packaged may be fetched and the non-containerized workload may be caused to be run locally on the client computing system. In some examples, a metric indicative of cost savings accrued by a vendor of the host application due to offloading may be tracked and at least a portion of the cost savings may be distributed to one or both of a subscriber of the host application and one or more third party stakeholders.

### TECHNICAL FIELD

Embodiments described herein generally relate to the field of decentralized computing and, more particularly, to decentralized compute infrastructure that facilitates making offload decisions and deploying modules, for example, for developers who would like to take advantage of local compute but would still use the cloud when needed to support host applications (e.g., web applications and/or native applications).

### BACKGROUND

Computing is centralized when critical application services are carried out solely by way of communication with a remote, central location, for example, when different users in different locations connect to the same service or address to access computing resources, such as data storage and processing. In contrast, computing is decentralized when critical application services are or may be carried out by individual computing devices or nodes on a distributed network, for example, on behalf of the users of the individual computing devices or nodes and/or on behalf of others. Decentralized infrastructure is an approach to implementing and operating digital infrastructure networks that lessen reliance on one centralized model or service provider, such as a Software-as-a-Service (SaaS) provider (e.g., streaming service providers, online gaming providers, and/or other independent software vendor (ISV) solutions delivered via a SaaS model), and instead allow individuals and businesses to potentially participate in networks as service providers (on behalf of themselves or others). Such participation can address challenges associated with traditional centralized networks, such as cost, risk, and scale, as well as lowering barriers to access and participation.

In the decentralized computing era, service providers and ISVs may offer incentives for offloading user sessions from a cloud instance to a client device and the resulting cost savings may be governed by and compensated for through transactions recorded on blockchains.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1A is a high-level block diagram illustrating a first example of an operational environment supporting decentralized compute infrastructure (DCI) according to some embodiments.

FIG. 1B is a high-level block diagram illustrating a second example of an operational environment supporting DCI according to some embodiments.

FIG. 2 is a block diagram illustrating a first example of a software architecture of a personal computer to support DCI according to some embodiments.

FIG. 3 is a block diagram illustrating a second example of a software architecture of a personal computer to support DCI according to some embodiments.

FIG. 4 is a block diagram illustrating a third example of a software architecture of a personal computer to support DCI according to some embodiments.

FIG. 5 is a block diagram illustrating a fourth example of a software architecture of a personal computer to support DCI according to some embodiments.

FIG. 6 is a block diagram illustrating a fifth example of a software architecture of a personal computer to support DCI according to some embodiments.

FIG. 7 is a flow diagram illustrating operations associated with a host application flow that makes use of a recommendation service according to some embodiments.

FIG. 8 is a flow diagram illustrating operations for performing offload authorization processing according to some embodiments.

FIG. 9 is a flow diagram illustrating operations for performing recommendation processing according to some embodiments.

FIG. 10 is an example of a computer system with which some embodiments may be utilized.

### DETAILED DESCRIPTION

Embodiments described herein are generally directed to decentralized compute infrastructure (DCI). Cloud native applications are normally containerized and then orchestrated through an orchestrator like Kubernetes in the cloud. Previous solutions for offloading user sessions to edge devices (e.g., client devices) involve opportunistically downloading the containers from the cloud onto a user's personal computer (PC) or laptop computer, for example, and then instantiating them using runtime infrastructure installed on the client, including Kubernetes, Docker Runtime, and a control plane for triggering the orchestration. One disadvantage of such prior solutions is that Kubernetes and Docket are heavy weight and resource intensive, thereby resulting in significant battery drain and central processing unit (CPU) consumption, which reduces the locally available compute resources for other applications running on the client device. Significant concerns have also been raised regarding the security model of this prior approach since the containers being downloaded may be malicious and may exfiltrate information from the client device, access to files on the client device by way of a ransomware attack, or otherwise harm the client device or contents thereof.

Various embodiments described herein seek to address or at least mitigate one or more of the limitations of existing decentralized computing techniques for various use cases. As described further below, according to one embodiment, a determination is made, for example, by a component of the proposed DCI regarding whether to execute a particular non-containerized workload associated with a host application in a cloud or on a client computing system on which the host application is running. After determining to execute the particular workload on the client computing system, a unit of execution in which the particular workload is packaged may be fetched and the particular workload may be caused to be run locally on the client computing system.

In some embodiments, despite the above-mentioned disadvantages relating to offloading of containerized workloads, it may still be worthwhile to the user (or subscriber) of a host application to allow offloading of containerized workloads from a SaaS cloud to a client computer system of the user when the user may be compensated (e.g., via utility tokens, cryptocurrency, or a statement credit on their subscription invoice) based on the cost savings (e.g., CSP cost savings) achieved due to the offloading.

As described further below, the proposed approach for DCI may include one or more of the following components in various combinations distributed among a client device, a SaaS cloud, in which a cloud-based service of a SaaS provider (e.g., an ISV or other provider of a cloud-based service) is hosted by a CSP, and an optional blockchain:
A host application (e.g., a web application or a native application) running on the client device and representing a frontend (or user interface) application through which the cloud-based service of the SaaS provider may be accessed by the user and that communicates with workloads associated with the cloud-based service, for example, via representational state transfer (REST) API calls.
An offload mechanism (e.g., an orchestration service) operable within the SaaS cloud or the cloud-based service that provides orchestration criteria to a requestor (e.g., a client orchestrator) to allow the requestor to evaluate whether to offload a particular workload associated with the host application from the SaaS cloud to the client device on which the host application is running.
A client orchestrator (or offload recommendation engine) operable on the client device that evaluates the orchestration criteria against capabilities (e.g., a static configuration) of the client device and/or capacity (e.g., a current dynamic state) of the client device to make recommendations regarding whether to shift a given workload to the client device.
A crediting or monetization mechanism (e.g., a payment smart contact or statement credit for a paid service) to facilitate sharing of the savings among one or more of various stakeholders (e.g., the owner of the client device, the ISV, and/or one or more other solution providers that facilitate or contribute to some aspect of the proposed DCI).
A telemetry or metering service that captures appropriate metrics that may be used for determining or otherwise estimating the savings resulting from running a given workload on the client device.

Advantageously, various embodiments, take better advantage of local compute capability and can offer improved latency and privacy. Additionally, the decreased cloud costs incurred by the SaaS provider may be shared among one or more of the various stakeholders, thereby encouraging support for and participation in the proposed solution.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

A “host application” generally refers to an application that is run on a client computer system. Non-limiting examples of a host application include a web application (or app) and a native application (or app).

A “web application” or “web app” generally refers to a host application that runs within a web browser. Web apps are generally only able to give users access to interactions supported by web browsers. As such, even though a web application may have rich design elements, it cannot access device features

A “native application” generally refers to a host application that has been developed for a particular operating system of a client computing system, thereby allowing it to run natively on the particular operating system.

A “unit of execution” or “unit of compute” generally refers to a package of software representing an application or program. Units of execution may be packaged in different formats. Non-limiting examples of units of execution include containers (stand-alone units of software that package up code and all its dependencies so the respective applications run quickly and reliable from one computing environment to another), WebAssembly (WASM) modules, and machine-learning (ML) models (e.g., a program or output generated after an ML algorithm is trained on training data). Non-limiting examples of ML models include Open Neural Network eXchange (ONNX) models and TensorFlow (TF) models.

As used herein “WebAssembly” or “WASM” generally refers to a portable binary-code format and a corresponding text format for executable programs that comply with the current or future releases of the WebAssembly Specification released on the webassembly.org website. WASM also defines software interfaces for facilitating interactions between executable programs and their host environment. WASM allows developers to run native code in a web browser. Unlike JavaScript, which is an interpreted language, WASM is a low-level language that is designed to be compiled from other programming languages like C and C++. This makes it possible to run high-performance code in the browser, which was previously not possible. WASM is supported by all major browsers, including Chrome, Firefox, Safari, and Edge, and therefore does not require a separate runtime environment when run in such browsers.

A “workload” generally refers to an application or program running on a computer system or within a computing environment (e.g., a virtual machine, a runtime environment, a container orchestration platform, such as Kubernetes). Non-limiting examples of workloads include compute intensive tasks (e.g., image processing, simulation, optimization, etc.), putting an ML model into production or operationalizing an ML model to make predictions or inferences, or other processes involving complex computations and that require a lot of processing power of a processing resource (e.g., central processing unit (CPU), a graphics processing unit (GPU), or an xPU (e.g., a Data Processing Unit (DPU), Infrastructure Processing Unit (IPU), Function Accelerator Card (FAC), Network Attached Processing Unit (NAPU), or other processing units that may offload and accelerate specialized tasks more efficiently than a general purpose CPU). In various embodiments described herein, a workload may be referred to as a containerized workload or a non-containerized workload. A “containerized workload” generally refers to a workload packaged within a container. A “non-containerized workload” generally refers to a workload that is not packaged within a container. Non-limiting examples of non-containerized workloads include workloads associated with WASM modules or ML models.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud service provider (e.g., a business, academic, or government organization, or some combination of them), and exists on the premises of the cloud service provider (CSP). The CSP may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). Similarly, an ISV, representing a subscriber of a CSP, may deliver solutions via a SaaS model to its customers or subscribers from a public cloud operated by the CSP. In the hybrid cloud deployment model, the cloud infrastructure is a composition of two or more distinct cloud infrastructures (private, community, or public) that remain unique entities, but are bound together by standardized or proprietary technology that enables data and application portability and mobility (e.g., cloud bursting for load balancing between clouds).

As used herein an “offload policy,” “offload criteria,” or “application preferences” generally refer to the criteria specifying the conditions for which offloading of a given workload from a cloud to a client computing system is permitted or not permitted. Non-limiting examples of offload criteria include one or more aspects of a static configuration (e.g., a minimum system configuration, a number of (CPUs, a number of CPU cores, an amount of system memory, the presence of a GPU, the presence of an xPU, etc.) or capability of the client computing system and one or more aspects of a dynamic state (e.g., CPU utilization, GPU utilization, xPU utilization, whether the system is running on battery or plugged in, battery level, network conditions (such as congestion), availability of sufficient memory and/or processing resources to perform a minimum number of inferences per unit of time, availability of sufficient memory to accommodate the size of the model at issue, etc.) or capacity of the client computing system. As explained further below, the offload policy may be defined and hosted in the SaaS cloud for a given workload or may be built into the host application.

A “digital token” or “crypto token” generally refers to a digital asset or a cryptocurrency that may be used to facilitate transactions on a blockchain or a digital representation of interest in an asset. Non-limiting examples of digital tokens include transactional tokens, governance tokens, utility tokens, security tokens, platform tokens, and non-fungible tokens (NFTs). Digital tokens may be created in accordance with a variety of different token standards, for example, Ethereum Request for Comments 20 (ERC-20) is the technical standard for fungible tokens (ERC-20 tokens) created using the Ethereum blockchain and Binance Smart Chain Evolution Proposal 20 (BEP-20) is the technical standard for fungible tokens (BEP-20 tokens) creating using the BNB Smart Chain (BCS) (formerly, the Binance Smart Chain).

The terms “module,” “component”, “engine”, “service,” and the like as used herein are intended to refer to a computer-related entity, either a software-executing general purpose processor, hardware, firmware, or a combination thereof. For example, a module or a component may be, but is not limited to being, a process running on a compute resource, an executable, a thread of execution, a program, and/or a computer.

### Example Operational Environments

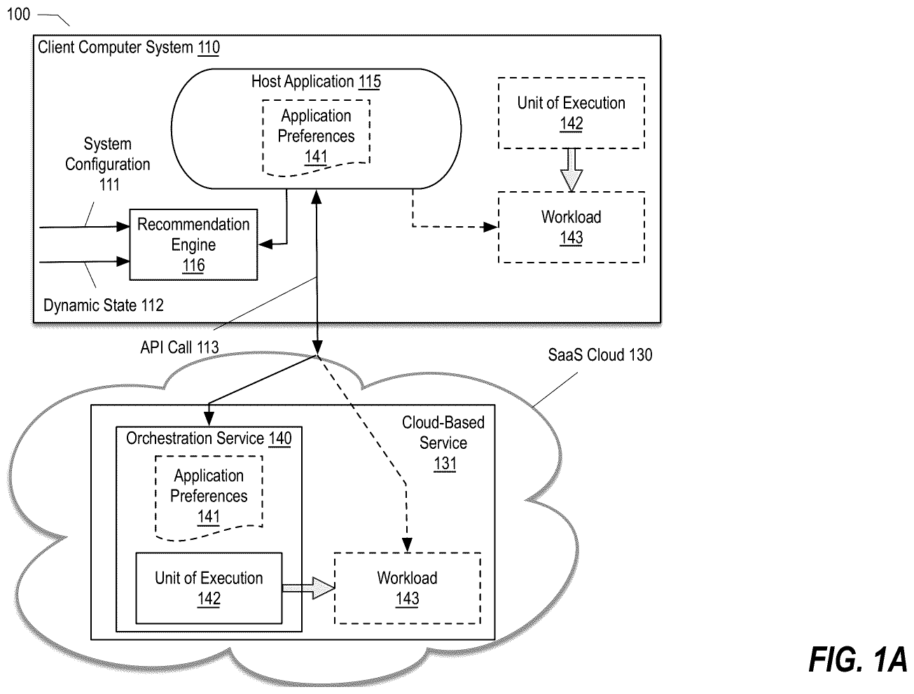

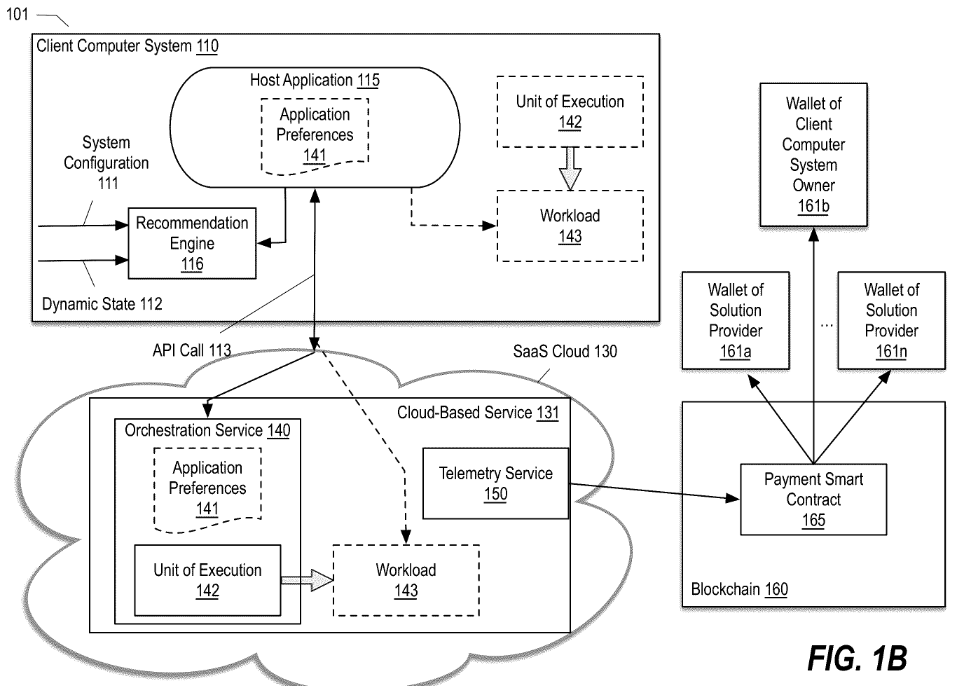

FIG. 1A is a high-level block diagram illustrating a first example of an operational environment 100 supporting decentralized compute infrastructure (DCI) according to some embodiments. In the context of the present example, the operational environment 100 is shown including a client computer system 110 and a SaaS cloud 130.

Client computer system 100 may represent a smartphone, a tablet computer, or a personal computer, such as a laptop computer or a desktop computer and may include a host application 115, a recommendation engine 116, a unit of execution 142, and a workload 143.

Host application 115 may represent a web app or a native app of a SaaS provider (e.g., a streaming service provider, an online gaming provider, an online collaboration service provider, and/or other provider, such as an ISV, of a cloud-based service (e.g., cloud-based service 131) delivered via a SaaS model). For example, using a streaming service provider (e.g., Spotify or Netflix) as an example, host application 115 may represent a frontend (or user interface) application (through which songs, playlists, television shows, or movies may be played) in the form of a native application (e.g., the Spotify app or the Netflix app) that may be downloaded, installed, and natively run on the client computer system 110. Alternatively, host application 115 may represent a frontend application in the form of a web app (e.g., a web player or a browser-based version of the Spotify app or the Netflix app) that may employ JavaScript, for example, and execute within a web browser (not shown) running on the client computer system 110 when the user is logged into their account.

Recommendation engine 116 may represent a client orchestrator (or offload recommendation engine) operable on the client computer system 110. Recommendation engine 116 may be responsible for evaluating application criteria 141 against the capabilities (e.g., static system configuration 111) and/or a current dynamic state 112 of the client computer system 110 to make recommendations regarding whether to shift a given workload (e.g., workload 143) from the SaaS cloud 130 to the client computer system 110. Application preferences 141 may specify one or more criteria defining the conditions for which offloading of a given workload (e.g., workload 143) from SaaS cloud 130 to client computing system 110 is permitted or not permitted. In the case of a video encoding, a video decoding, or a video editing workload, for example, application preferences 141 may specify a minimum system configuration that includes a GPU or a CPU having at least six cores and a threshold amount of random access memory (RAM) as well as a minimum availability of capacity of the GPU, CPU, and/or RAM to accommodate the workload at issue. In the case of an ML workload, for example, application preferences 141 may specify a minimum system configuration that includes either a GPU or an xPU (e.g., a neural processing unit) as well as a minimum availability of capacity of the GPU or the xPU to accommodate the workload at issue. Depending on the particular implementation, recommendation engine 116 may be in the form of a separate application or a library that may be packaged with the host application 115.

Turning now to SaaS cloud 130, it may represent the particular public cloud (e.g., Amazon Web Service, Microsoft Azure, or Google Cloud Platform) of a CSP (Amazon, Microsoft, or Google, respectively) contracted by the SaaS provider to host the cloud-based service 131. In the context of the present example, SaaS cloud 130 is shown including within the cloud-based service 131, an orchestration service 140 and a workload 143. As those skilled in the art will appreciate, host application 115 may communicate with workload 143 or otherwise interact with the cloud-based service 131 via API calls (e.g., API call 113, which may be in the form of representational state transfer (REST) API calls, graph query language (GraphQL) API calls, gRPC remote procedure calls (gRPC), WebSocket API calls, or the like).

Orchestration service 140 represents an offload mechanism operable within SaaS cloud 130 that may provide application preferences 141 to a requestor (e.g., recommendation engine 116) to facilitate evaluation by the requester whether to offload a particular workload (e.g., workload 143) associated with the host application 115 from SaaS cloud 130 to client computer system 110. After an offload decision has been made by the recommendation engine 316 to locally run the particular workload, orchestration service 140 may be used to deliver to client computer system 110 from SaaS cloud 130 a given unit of execution (e.g., unit of execution 142), for example, a container, a WASM module, an ML model (e.g., an Open Neural Network Exchange (ONNX) model or a TensorFlow model), or the like, in which the particular workload is packaged to allow the particular workload to be run on a selected processing resource (not shown) (e.g., a CPU, a GPU, or an xPU) of client computer system 110.

While in the context of the present example, a given unit of execution (e.g., unit of execution 142), for example, containing code representing and supporting a given workload (e.g., workload 143) is shown as initially existing in SaaS cloud 130 and being selectively retrieved, for example, by recommendation engine 116 or host application 115 for local execution on client computer system 110, it is to be appreciated the given unit of execution may alternatively be stored in a separate repository from which it may be retrieved by SaaS cloud 130 and/or client computer system 110 as needed. Similarly, while only a single unit of execution and a corresponding single workload are shown, it is to be appreciated multiple units of execution and multiple corresponding workloads may be offloaded from SaaS Cloud 140 to client computer system 110.

FIG. 1B is a high-level block diagram illustrating a second example of an operational environment 101 supporting DCI according to some embodiments. In the context of the present example, the differences between operational environment 100 of FIG. 1A and operational environment 101 of FIG. 1B is the addition of various wallets 161a-n, the inclusion of a telemetry service 150 within the cloud-based service 131, and the addition of a crediting or monetization mechanism (e.g., a payment smart contact 165 stored on a blockchain 160) to facilitate sharing of cost savings (e.g., reduced usage of CSP resources) achieved by offloading one or more workloads (e.g., workload 143) from SaaS cloud to client computer system 110. In one embodiment, such cost savings may be distributed among one or more of various stakeholders, for example, the owner of client computer system 110, the ISV, and/or one or more other solution providers (e.g., the developer of recommendation engine 116, the CSP, etc.) that facilitate or contribute to some aspect of the proposed DCI.

According to one embodiment, the blockchain 160 may represent a layer 1 base network (or public blockchain network), for example an Ethereum blockchain, that is used to, in a trusted manner, keep account of how much compute offload took place as a result of allowing one or more workloads (e.g., workload 143) to be offloaded from SaaS cloud 130 to client computer system 110. Depending upon the particular implementation, a separate chain (e.g., a layer 2 or a layer 3 blockchain/sidechain) may additionally or alternatively be used to provide privacy and confidentiality of the metering data collected and communicated to blockchain 160 (if desired by the SaaS provider).

The telemetry service 150 may be responsible for collecting metric data indicative cost savings accrued by the SaaS provider. Those skilled in the art will appreciate there are a number of ways to measure such cost savings, including, for example, (i) assigning a cost to each API call (e.g., API call 113) and tracking the number of API calls made by host application 115, (ii) measuring an amount of offload based on a difference between CSP resource usage by the SaaS provider before and after a given workload is offloaded to the client computer system 110, and/or (iii) measuring resource usage (e.g., CPU cycles) performed by the client computer system 110 to execute the given workload. Depending upon the particular implementation, the metering of resource usage on the client computer system 111 or of CSP resource usage by the cloud-based service 131, by be performed by the SaaS provider or with the assistance of a third-party SaaS metering service or public blockchain company (e.g., Akash.network, Sonm, Golem, Fluence, Spheron, or the like).

Telemetry service 150 may also determine an amount of digital tokens to be distributed to one or more of the various stakeholders based on a predetermined or configurable algorithm or formula (e.g., that performs or is used to perform a conversion from the measurement or metric used to estimate or track the SaaS provider's cost savings to digital tokens and/or an allocation or sharing of cost savings). This allocation or sharing of cost savings may be the subject of a formal cost savings sharing agreement between/among the individual stakeholders and the SaaS provider. The cost savings sharing agreement may specify the terms and conditions as well as the approach used to perform tokenized metering. For example, based on the cost savings accrued by the SaaS provider due to the offloading performed by a given client computer system over a period of time (e.g., one month), the owner (e.g., the user or subscriber of the cloud-based service 131) of the client computing system 110 may be allocated a percentage (e.g., 20% to 33%) of the cost savings. Additionally, a first solution provider (e.g., the developer of recommendation engine 116) may be allocated a percentage (e.g., 20% to 33%) of the cost savings. Further still, a second solution provider (e.g., the CSP or other partner) may be allocated a percentage (e.g., 10% to 20%) of the cost savings. Any remaining cost savings may be retained by the SaaS provider. Alternatively, the SaaS provider may retain the entirety of the cost savings.

According to one embodiment, telemetry service 150 may periodically push the collected metrics (in raw form or converted to digital tokens) indicative of cost savings accrued to the SaaS provider on a per client device basis to payment smart contract 165 (and/or another crediting or monetization mechanism). For its part, payment smart contract 165 may be responsible for crediting the wallets 161a-n of the stakeholders.

While in the context of the present example, payment smart contract 165 is described as a non-limiting example of a crediting or monetization mechanism to facilitate sharing of costs savings (e.g., CSP resource utilization costs) among one or more of various stakeholders to encourage participation and/or support for the proposed DCI, it is to be appreciated a statement credit may additionally or alternatively issued on a periodic basis to a subscriber of a paid service (e.g., a monthly or annual subscription for the loud-based service 131). As yet another example of a crediting or monetization mechanism, the SaaS provider may offer a discounted subscription plan to subscribers having a client computer system (e.g., client computer system 110) having sufficient capabilities and that agree to allow workloads (e.g., workload 143) of the cloud-based service 131 to be offloaded to the client computer system as appropriate.

### Example Client Device Software Architectures

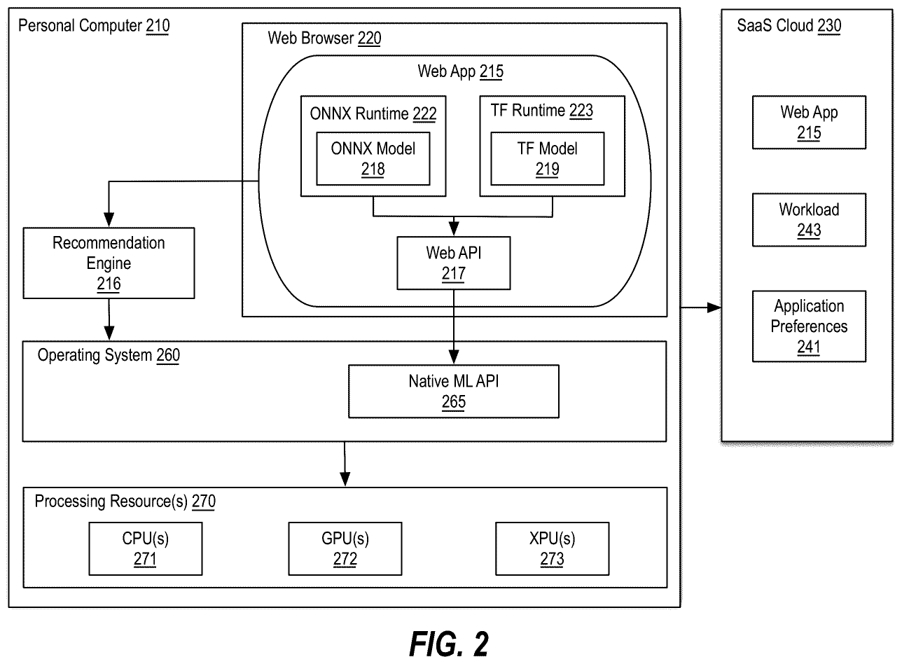

FIG. 2 is a block diagram illustrating a first example of a software architecture of a personal computer 210 to support DCI according to some embodiments. In the context of the present example, personal computer 210 (which may be analogous to client computer system 110) is shown interacting with a SaaS cloud 230 (which may be analogous to SaaS cloud 130). In one embodiment, personal computer 210 includes a web browser 220 (e.g., Google Chrome, Firefox, Microsoft Edge, Internet Explorer, or the like), a recommendation engine 216 (which may be analogous to recommendation engine 116), an operating system 260, and a set of one or more processing resources 270.

Depending on the static system configuration of personal computer 210, the set of one or more processing resources 270 may include one or more CPUs 271, one or more GPUs 272, and one or more xPU(s) 273.

Operating system 260 may represent a current or future release of the Microsoft Windows operating system, one of a variety of currently available or future Linux operating system distributions (e.g., Deepin, Fedora, Zorin OS, Solus, Debian, Ubuntu, Linux Mint, etc.), or the like. Operating system 260 is shown including a native ML API 265 (e.g., a low-level API for ML) that may provide high-performance, hardware-accelerated ML primitives to support, among other things, ML model inferencing. A non-limiting example of native ML API 265 includes Direct Machine Learning (DirectML). Native ML API 265 may facilitate efficient execution of an inference model on a GPU (e.g., one of GPUs 272) and/or on an artificial intelligence (AI)-acceleration core (e.g., one of xPUs 273).

Web browser 220 may run a web app 215 retrieved by web browser 220 from SaaS cloud 230, for example, as a result of a user making use of or otherwise accessing a cloud-based service (e.g., cloud-based service 131) offered by a SaaS provider that is hosted by a CSP in SaaS cloud 230.

Web app 215 may be coded in JavaScript and may represent a frontend application through which interactions with the cloud-based service are achieved. In the context of the present example, web app 215 is shown including an ONNX runtime 222 and a TensorFlow (TF) runtime 223 for executing an ONNX model 218 and a TF model 219 respectively, which may represent a unit of execution within which a workload 243 (which may be analogous to workload 143) is packaged. Web app 215 is also shown including a web API 217, representing an interface through which web app 215 may make use of native ML API 265. Depending on the particular implementation web API 217 may represent a JavaScript API. Non-limiting examples of web API 215 include the Web Graphics Library (WebGL) API, which facilities rendering high-performance interactive three-dimensional (3D) and two-dimensional (2D) graphics within a compatible web browser, and the Web Neural Network (WebNN) API, which allows web apps, such as web app 215, to accelerate deep neural networks with on-device hardware, such as GPUs 272, CPUs 271, or purpose-built AI accelerators (e.g., a neural processing unit of xPUs 273).

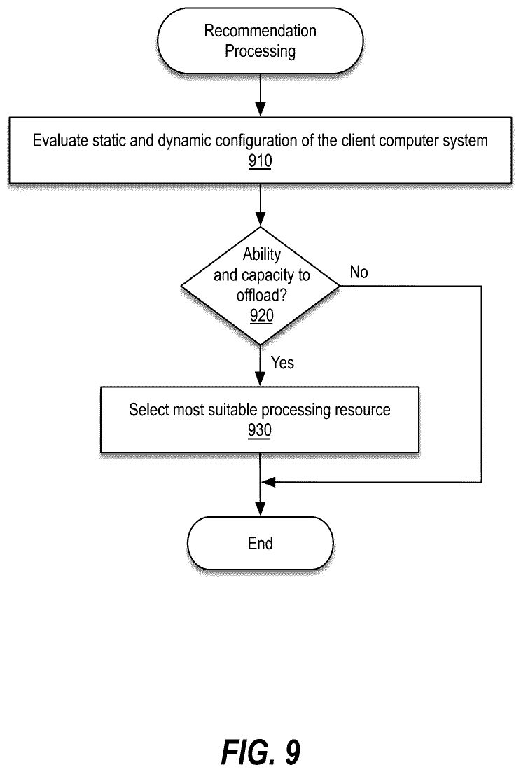

When offloading is enabled or otherwise authorized to be performed by personal computer 210, before retrieving a unit of execution containing a given workload (e.g., workload 243) for local execution, web app 215 may request recommendation engine 216 to evaluate the capability and capacity of personal computer 210 to accommodate shifting of the given workload from SaaS cloud 230 to personal computer 210, for example, based on one or more of the static system configuration (e.g., system configuration 111), a current dynamic state (e.g., dynamic state 112) of personal computer 210, and application preferences 241 (which may be analogous to application preferences 141) associated with the given workload. Furthermore, the recommendation engine 216 may select the most suitable processing resource from among processing resources 270 for the given workload. A non-limiting example of recommendation processing that may be performed by recommendation engine 216 is described further below with reference to FIG. 9.

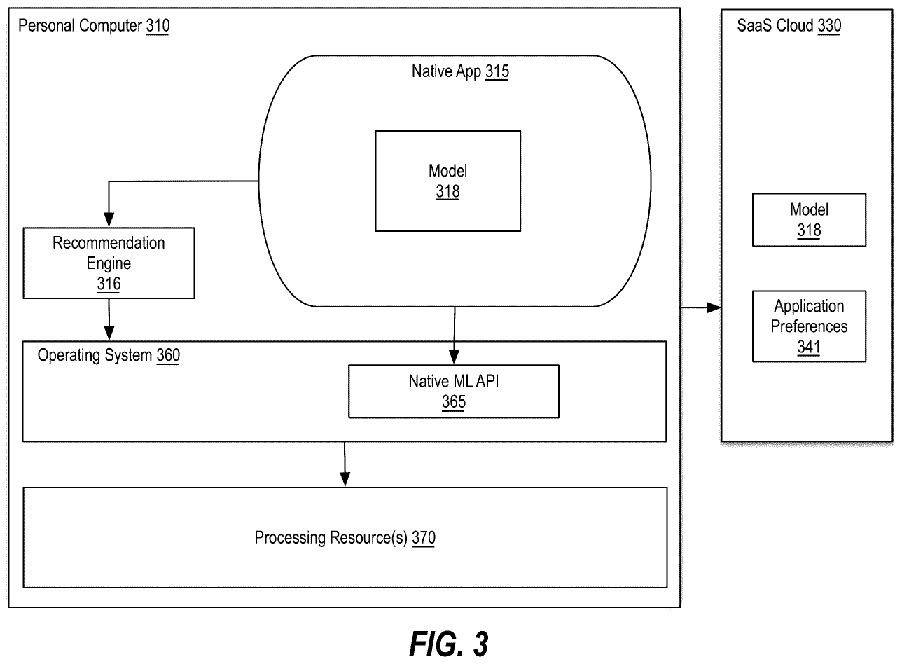

FIG. 3 is a block diagram illustrating a second example of a software architecture of a personal computer 310 to support DCI according to some embodiments. In the context of the present example, personal computer 310 (which may be analogous to client computer system 110) is shown interacting with a SaaS cloud 330 (which may be analogous to SaaS cloud 130). In one embodiment, personal computer 310 includes a native app 315 (which may be analogous to host application 115), a recommendation engine 316 (which may be analogous to recommendation engine 116 or 216), an operating system 360 (which may be analogous to operating system recommendation 260), and a set of one or more processing resources 370 (which may be analogous to processing resources 270).

Operating system 360 is shown including a native ML API 365 (which may be analogous to native ML API 265).

Native app 315 may represent a frontend application through which interactions with a cloud-based service (e.g., cloud-based service 131) offered by a SaaS provider that is hosted by a CSP in SaaS cloud 330. In the context of the present example, native app 315 is shown including a model 318 (e.g., an ONNX model, a TF model, or the like), which may represent a unit of execution within which a workload (not shown) is packaged.

As above, when offloading is enabled or otherwise authorized to be performed by personal computer 310, before retrieving a unit of execution (e.g., model 318) containing a given workload for local execution, native app 315 may request recommendation engine 316 to evaluate the capability and capacity of personal computer 310 to accommodate shifting of the given workload from SaaS cloud 330 to personal computer 310, for example, based on one or more of the static system configuration (e.g., system configuration 111), a current dynamic state (e.g., dynamic state 112) of personal computer 310, and application preferences 341 (which may be analogous to application preferences 141) associated with the given workload. Furthermore, the recommendation engine 316 may select the most suitable processing resource from among processing resources 370 for the given workload.

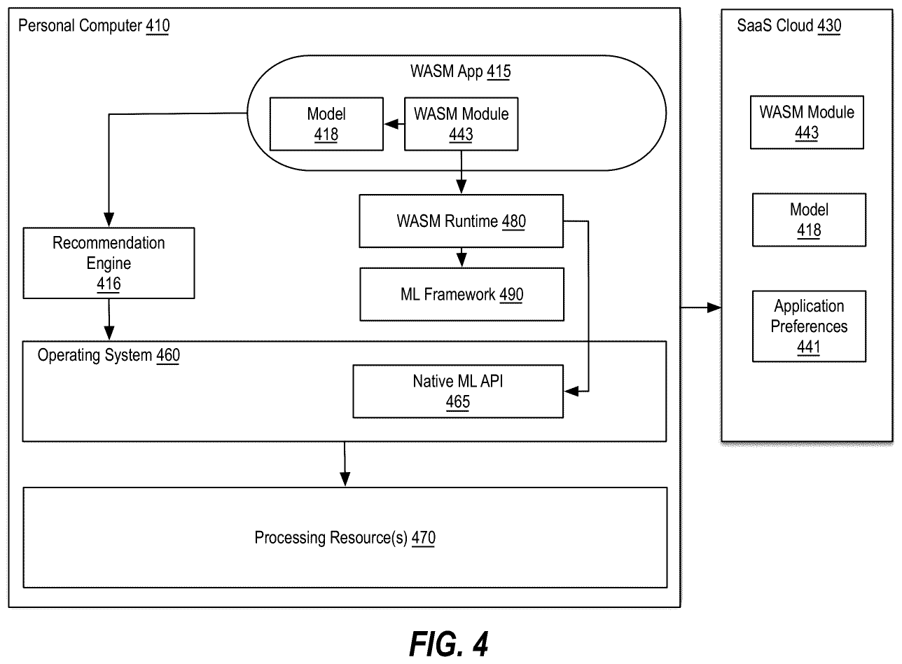

FIG. 4 is a block diagram illustrating a third example of a software architecture of a personal computer 410 to support DCI according to some embodiments. In the context of the present example, personal computer 410 (which may be analogous to client computer system 110) is shown interacting with a SaaS cloud 430 (which may be analogous to SaaS cloud 130). In one embodiment, personal computer 410 includes a WASM app 315 (which may be analogous to host application 115), a recommendation engine 416 (which may be analogous to recommendation engine 116 or 216), a WASM runtime 480, an ML framework 490, an operating system 460 (which may be analogous to operating system recommendation 260), and a set of one or more processing resources 470 (which may be analogous to processing resources 270).

ML framework 490 may represents any tool, interface, or library that facilitates building and deployment of ML models. Non-limiting examples of ML framework 690 include ONNX, TensorFlow, Keras, H2O, Shogun, Scikit Learn, and PyTorch.

WASM runtime 480 may represent a compiler and runtime for compiling WASM code (e.g., WASM module 443) and a virtual machine for running the resulting WASM binary.

Operating system 460 is shown including a native ML API 465 (which may be analogous to native ML API 265).

WASM app 315 may represent a frontend application through which interactions with a cloud-based service (e.g., cloud-based service 131) offered by a SaaS provider that is hosted by a CSP in SaaS cloud 430. In the context of the present example, WASM app 415 is shown including a model 418 and a WASM module 443, which may represent a unit of execution within which a workload (e.g., model 418) is packaged. Non-limiting examples of model 418 include an ONNX model and a TF model.

As above, when offloading is enabled or otherwise authorized to be performed by personal computer 410, before retrieving a unit of execution (e.g., WASM module 443 18) containing a given workload (e.g., model 418) for local execution, WASM app 415 may request recommendation engine 416 to evaluate the capability and capacity of personal computer 410 to accommodate shifting of the given workload from SaaS cloud 430 to personal computer 410, for example, based on one or more of the static system configuration (e.g., system configuration 111), a current dynamic state (e.g., dynamic state 112) of personal computer 410, and application preferences 441 (which may be analogous to application preferences 141) associated with the given workload. Furthermore, the recommendation engine 416 may select the most suitable processing resource from among processing resources 470 for the given workload.

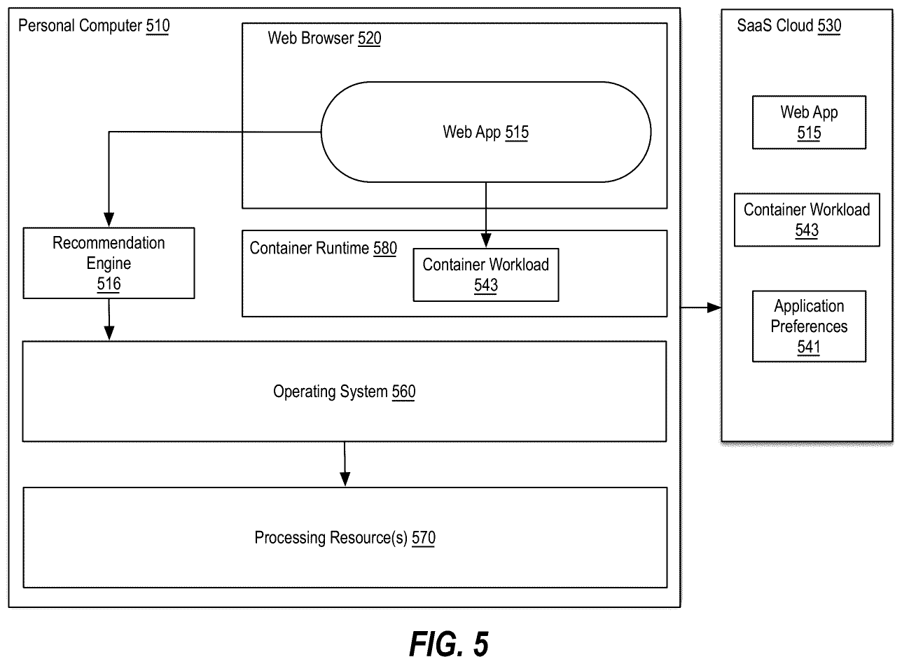

FIG. 5 is a block diagram illustrating a fourth example of a software architecture of a personal computer 510 to support DCI according to some embodiments. In the context of the present example, personal computer 510 (which may be analogous to client computer system 110) is shown interacting with a SaaS cloud 530 (which may be analogous to SaaS cloud 130). In one embodiment, personal computer 510 includes a web browser 520, (which may be analogous to web browser 220), a recommendation engine 516 (which may be analogous to recommendation engine 116 or 216), an operating system 560 (which may be analogous to operating system recommendation 260), a container runtime 580, and a set of one or more processing resources 570 (which may be analogous to processing resources 270).

Web browser 520 may run a web app 515 (which may be analogous to web app 215) retrieved by web browser 520 from SaaS cloud 530, for example, as a result of a user making use of or otherwise accessing a cloud-based service (e.g., cloud-based service 131) offered by a SaaS provider that is hosted by a CSP in SaaS cloud 530. Web app 315 may represent a frontend application through which interactions with the cloud-based service are facilitated.

Container runtime 580 may represent a software component that can run containers on a host operating system (e.g., operating system 560). Non-limiting examples of container runtime 580 include Docker, containerd, and any implementation of the Kubernetes container runtime interface (CRI). In the context of the present example, container runtime 580 is shown running a containerized workload (e.g., container workload 543), for example, downloaded to the personal computer 510 in the form of a unit of execution (e.g., a container (not shown)) and instantiated using container runtime 580.

As above, when offloading is enabled or otherwise authorized to be performed by personal computer 510, before retrieving a unit of execution (e.g., a container) packaging a given container workload (e.g., container workload 543) for local execution, web app 515 may request recommendation engine 516 to evaluate the capability and capacity of personal computer 510 to accommodate shifting of the given workload from SaaS cloud 530 to personal computer 510, for example, based on one or more of the static system configuration (e.g., system configuration 111), a current dynamic state (e.g., dynamic state 112) of personal computer 310, and application preferences 541 (which may be analogous to application preferences 141) associated with the given workload. Furthermore, the recommendation engine 516 may select the most suitable processing resource from among processing resources 570 for the given workload.

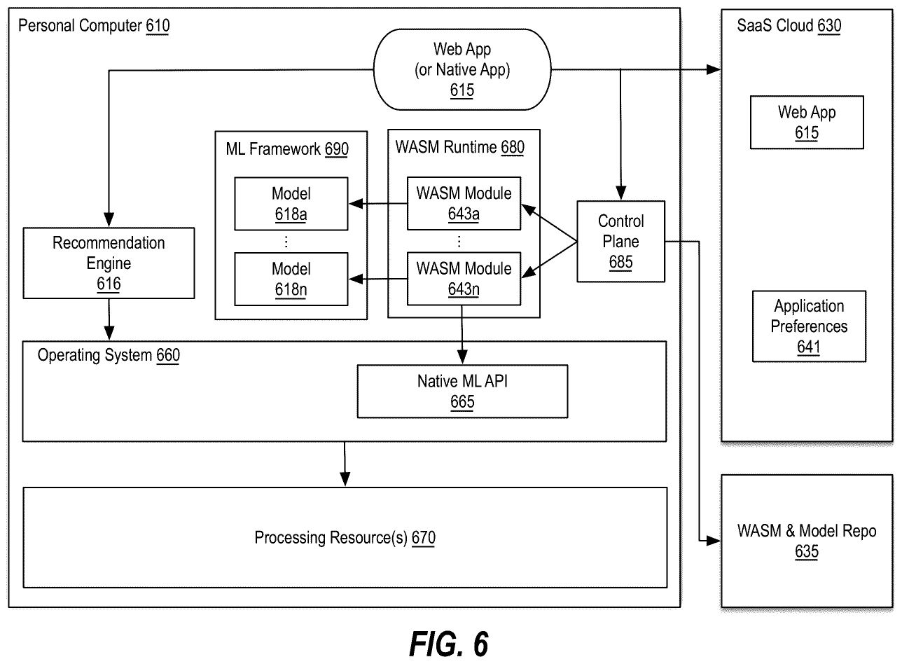

FIG. 6 is a block diagram illustrating a fifth example of a software architecture of a personal computer 610 to support DCI according to some embodiments. In the context of the present example, personal computer 610 (which may be analogous to client computer system 110) is shown interacting with a SaaS cloud 630 (which may be analogous to SaaS cloud 130). In one embodiment, personal computer 610 includes a web app or a native app 615 (which may be analogous to web app 215 or native app 315), a recommendation engine 616 (which may be analogous to recommendation engine 116), an ML framework 690 (which may be analogous to ML framework 490), a WASM runtime 680 (which may be analogous to WASM runtime 480), a control plane 685, an operating system 260, and a set of one or more processing resources 570 (which may be analogous to processing resources 270).

In the context of the present example, ML framework 690 is shown having models 618a-n deployed therein, which may each represent an ONNX model, a TF model, or the like. In the context of the present example, WASM runtime 680 is shown executing WASM modules 643a-n corresponding to models 618a-n, respectively.

Control plane 685 may represent a distributed intelligent control plane for triggering the orchestration of units of execution (e.g., WASM modules 643a-n) retrieved from an external WASM & model repository 635 (e.g., WASM Hub or the like).

Operating system 660 is shown including a native ML API 665 (which may be analogous to native ML API 265).

When offloading is enabled or otherwise authorized to be performed by personal computer 610, before retrieving a unit of execution containing a given workload (e.g., model 618a-n) for local execution, web app or native app 615 may request recommendation engine 616 to evaluate the capability and capacity of personal computer 610 to accommodate shifting of the given workload from SaaS cloud 630 to personal computer 610, for example, based on one or more of the static system configuration (e.g., system configuration 111), a current dynamic state (e.g., dynamic state 112) of personal computer 210, and application preferences 641 (which may be analogous to application preferences 141) associated with the given workload. Furthermore, the recommendation engine 616 may select the most suitable processing resource from among processing resources 670 for the given workload.

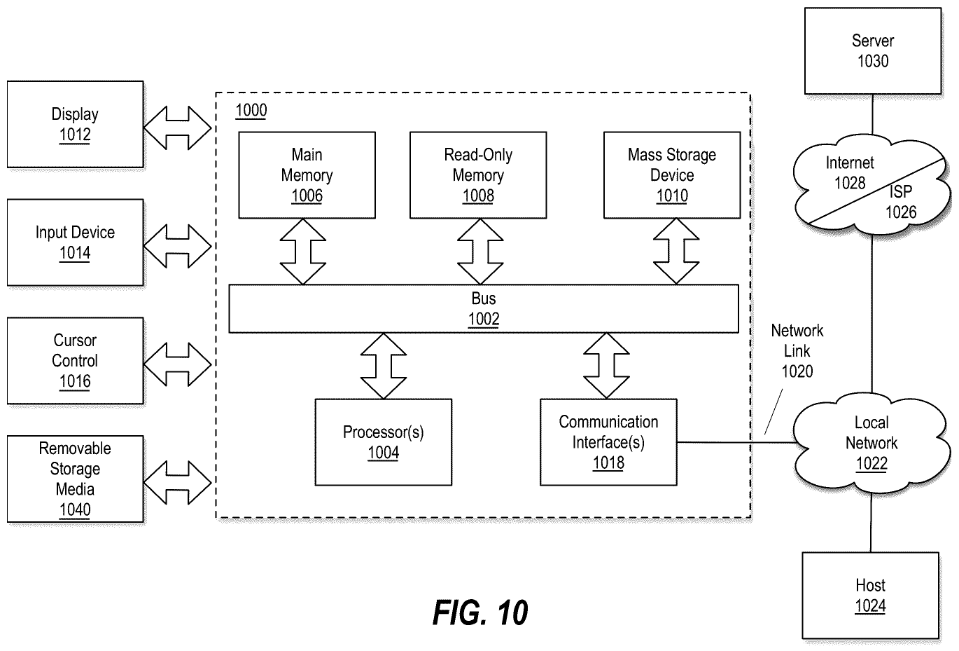

The various software components (e.g., recommendation engine 116, 216, 316, 416, 516, and 616, host application 115, cloud-based service 131, orchestration service 140, telemetry service 150, payment smart contract 165, web browser 220 and 520, web app 215 and 515, native app 315, WASM app 415, WASM runtime 480 and 680, ML framework 490 and 690, container runtime 580, etc.) described herein, and the processing described below may be implemented in the form of executable instructions stored on one or more machine readable media and executed by one or more processing resources (e.g., a microcontroller, a microprocessor, a CPU core, a CPU, a GPU, an xPU, an application-specific integrated circuit (ASIC), a field programmable gate array (FPGA), and the like) and/or in the form of other types of electronic circuitry. For example, the processing may be performed by one or more virtual or physical computer systems of various forms, such as, for example, the computer system described below with reference to FIG. 10.

### Example Host Application and Recommendation Service Flow

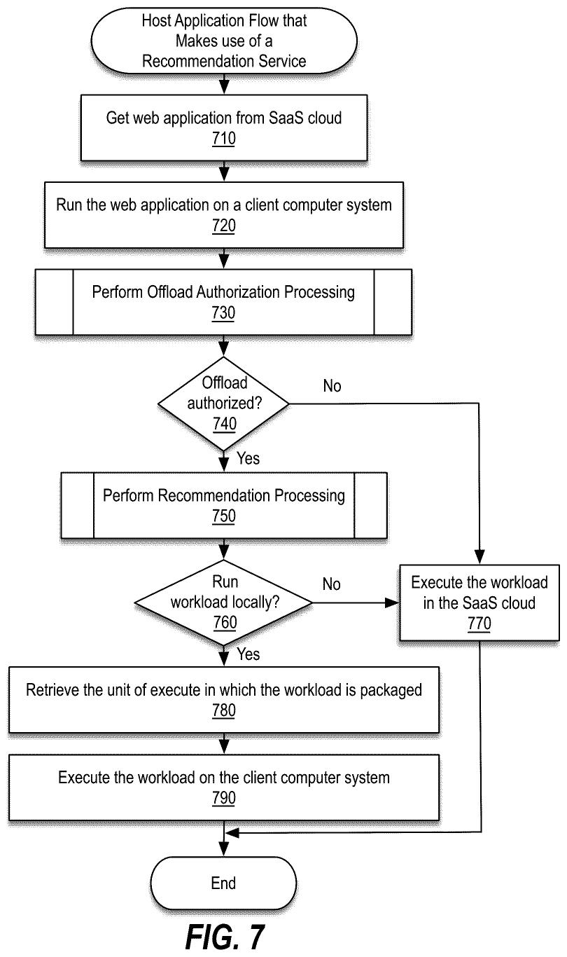

FIG. 7 is a flow diagram illustrating operations associated with a host application flow that makes use of a recommendation service according to some embodiments. The processing described with reference to FIG. 7 may be performed within operational environment 100 or 101.

At block 710, a web application (e.g., web app 215) is retrieved, for example, by a web browser (e.g., web browser 220) running on a client computer system (e.g., personal computer 210) from a SaaS cloud (e.g., SaaS cloud 230). For example, after a user logs into their account with a SaaS provider to access a cloud-based service (e.g., cloud-based service 131) offered by the SaaS provider, JavaScript representing the web application may be downloaded by the web browser.

At block 720, the web application is run on the client computer system.

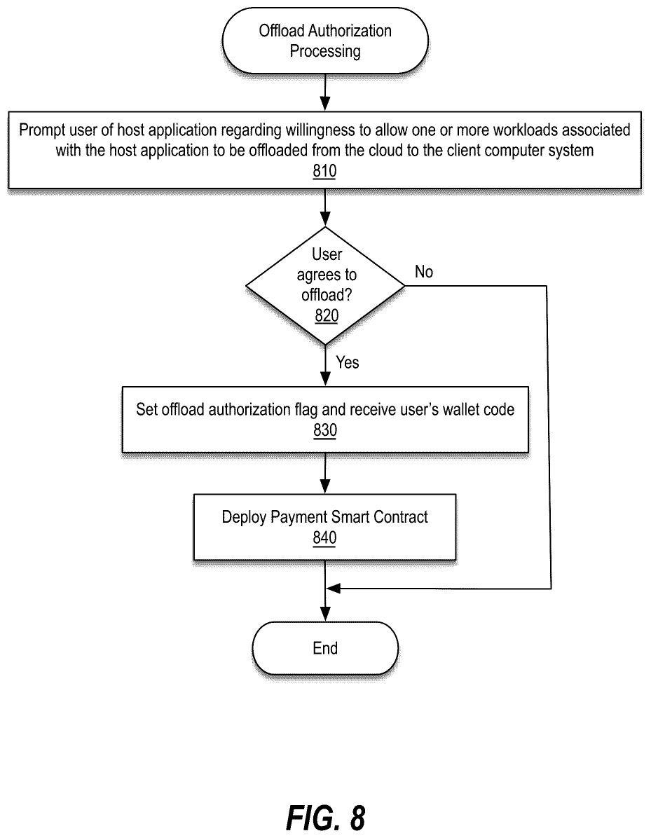

At block 730, offload authorization processing may be performed by the web application. For example, the first time the web application is run or each time the web application is run, various checks may be performed to determine whether offloading of one or more workloads (e.g., workload 243) from the SaaS cloud to the client computer system is authorized by the user (e.g., the owner of the client computer system). A non-limiting example of offload authorization processing is described further below with reference to FIG. 8.

At decision block 740, it is determined whether offloading was authorized in block 730. If so, processing continues with block 750; otherwise, processing branches to block 770.

At block 750 recommendation processing is performed. For example, the web application may make a request to a recommendation engine (e.g., recommendation 216) for a recommendation regarding whether a given workload (e.g., workload 243) is to be run locally. A non-limiting example of recommendation processing is described further below with reference to FIG. 9.

At decision block 760, it is determined whether the recommendation of block 750 was to run the workload locally. If so, processing continues with block 780; otherwise, processing branches to block 770.

At block 770, the workload at issue is executed in the SaaS cloud 770.

At block 780, the unit of execution in which the workload is package is retrieved, for example, from the SaaS cloud or from an external repository (e.g., WASM & model repo 635). The unit of execute may be a container, a WASM module (e.g., WASM module 443 or WASM module 643a-n), or an ML model (e.g., ONNX model 218, TF model 219,)

While in the context of the present example, blocks 750-790 are shown for a single workload, it is to be appreciated during the user interactions with the cloud-based service, the recommendation processing and selective execution of workloads in the SaaS cloud or on the client computer system may be performed multiple times. Similarly, while the present example is described with reference to a web application, the methodology is equally applicable to native applications (e.g., native app 315) and WASM applications (e.g., WASM app 415), albeit without the involvement of a web browser.

### Example Offload Authorization Processing

FIG. 8 is a flow diagram illustrating operations for performing offload authorization processing according to some embodiments. The processing described with reference to FIG. 8 may be performed by a host application (e.g., host application 115) running on a client computer system (e.g., client computer system 110 or personal computer 210, 310, 410, 510, or 610). The host application may be a web app (e.g., web app 215, 515, or 615) running within a web browser (e.g., web browser), a native app (e.g., native app 315 or 615), or a WASM app (e.g., WASM app 415).

At block 810, a user of the host application may be prompted regarding their willingness to allow one or more workloads associated with the host application to be offloaded from a cloud (e.g., SaaS cloud 130) to the client computer system on which the host application is running. For example, during configuration of the host application, during the first run of the host application, or each time the host application is run, the host application may present the user with an option to allow or disallow offloading. In some embodiments, the host application may have the user accept or reject a formal cost savings sharing agreement that may specify terms and conditions for participating in the cost savings sharing agreement as well as the approach used measure and share the cost savings achieved by the SaaS provider due to offloading performed by the client computer system.

At decision block 820, a determination is made regarding whether the user has agreed to the performance of offloading. If so, processing continues with block 830; otherwise, offload authorization processing is complete.

At block 830, an offload authorization flag may be set to indicate the users agreement to allow offloading and the user's wallet code is received from the user, for example, to allow the user to share in the cost savings (e.g., by way of a periodic distribution of digital tokens by or on behalf of the SaaS provider) achieved by the SaaS provider due to the offloading performed by the client computer system.

At block 840, to the extent cost savings are shared with the user, a payment smart contract (e.g., payment smart contract 165) may be configured accordingly and deployed on a block chain (e.g., block chain 160).

### Example Recommendation Processing

FIG. 9 is a flow diagram illustrating operations for performing recommendation processing according to some embodiments. The processing described with reference to FIG. 9 may be performed by a recommendation engine (e.g., recommendation engine 116, 216, 316, 416, 516, or 616) operable within a client computer system (e.g., client computer system 110 or personal computer 210, 310, 410, 510, or 610). As noted above, the recommendation engine may be a separate application or a library that may be package with a host application (e.g., host application 115). In the context of the present example, it is assumed a workload (e.g., workload 143) is about to be executed to support a cloud-based service (e.g., cloud-based service 131) of a SaaS provider and a host application (e.g., host application 110) has made a request to the recommendation engine for a recommendation on whether to run the workload locally on the client computer system.

At block 910, a static system configuration (e.g., system configuration 111) and a dynamic state (e.g., dynamic state 112) of the client computer system are evaluated with reference to application preferences (e.g., application preferences 141). The application preferences may specify the conditions for which offloading of a given workload from a SaaS cloud (e.g., SaaS cloud 130) to the client computing system is permitted or not permitted. For example, the application preferences may include one or more aspects of the static system configuration (e.g., a minimum system configuration, a number of (CPUs, a number of CPU cores, an amount of system memory, the presence of a GPU, the presence of an xPU, etc.) or capability of the client computing system and one or more aspects of the dynamic state (e.g., CPU utilization, GPU utilization, xPU utilization, whether the system is running on battery or plugged in, battery level, network conditions (such as congestion), availability of sufficient memory and/or processing resources to perform a minimum number of inferences per unit of time, availability of sufficient memory to accommodate the size of the model at issue, etc.) or capacity of the client computing system. Depending on the particular implementation, the application preferences may be defined and hosted in the SaaS cloud and accessible to the host application or the recommendation engine, for example, via an orchestration service (e.g., orchestration service 140) or the application preferences may be built into the host application.

At decision block 920, it is determined whether the client computer system has both the capability and the capacity to accommodate offloading of the workload at issue from the SaaS cloud. If so, processing continues with block 930; otherwise, recommendation processing is complete.

At block 930, the most suitable processing resource (e.g., one of processing resources 270), for example, a CPU of a number of available CPUs (e.g., 271), a GPU of a number of available GPUs (e.g., GPUs 272), or an xPU of a number of available xPUs (e.g., xPUs 273) for execution of the workload at issue may also be selected based on the characteristics of the workload at issue. For example, a CPU having lesser utilization may be selected for a workload involving a compute intensive task. Similarly, a GPU or an xPU may be selected for performing predictions or inferences associated with an ML workload.

While in the context of the examples described with reference to the flow diagrams of FIGS. 7-9, a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

FIG. 10 is an example of a computer system 1000 with which some embodiments may be utilized. Computer system 1000 may represent some, all, or a subset of components of a client computer system (e.g., client computer system 110) or a computer system associated with a SaaS cloud (e.g., SaaS cloud 130). Notably, components of computer system 1000 described herein are meant only to exemplify various possibilities. In no way should example computer system 1000 limit the scope of the present disclosure. In the context of the present example, computer system 1000 includes a bus 1002 or other communication mechanism for communicating information, and a processing resource (e.g., one or more hardware processors 1004) coupled with bus 1002 for processing information. The processing resource may be, for example, one or more general-purpose microprocessors or a system on a chip (SoC) integrated circuit.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, e.g., a magnetic disk, optical disk or flash disk (made of flash memory chips), is provided and coupled to bus 1002 for storing information and instructions.

Computer system 1000 may be coupled via bus 1002 to a display 1012, e.g., a cathode ray tube (CRT), Liquid Crystal Display (LCD), Organic Light-Emitting Diode Display (OLED), Digital Light Processing Display (DLP) or the like, for displaying information to a computer user. An input device 1014, including alphanumeric and other keys, is coupled to bus 1002 for communicating information and command selections to processor 1004. Another type of user input device is cursor control 1016, such as a mouse, a trackball, a trackpad, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Removable storage media 1040 can be any kind of external storage media, including, but not limited to, hard-drives, floppy drives, IOMEGA® Zip Drives, Compact Disc-Read Only Memory (CD-ROM), Compact Disc—Re-Writable (CD-RW), Digital Video Disk-Read Only Memory (DVD-ROM), USB flash drives and the like.

Computer system 1000 may implement the techniques described herein using customized hard-wired logic, one or more ASICs or FPGAs, firmware or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1010. Volatile media includes dynamic memory, such as main memory 1006. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes interface circuitry 1018 coupled to bus 1002. The interface circuitry 1018 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 1018 may couple the processing resource in communication with one or more discrete accelerators (e.g., one or more XPUs).

Interface 1018 may also provide a two-way data communication coupling to a network link 1020 that is connected to a local network 1022. For example, interface 1018 may be an integrated services digital network (ISDN) card, cable modem, satellite modem, or a modem to provide a data communication connection to a corresponding type of telephone line. As another example, interface 1018 may be a local area network (LAN) card to provide a data communication connection to a compatible LAN. Wireless links may also be implemented. In any such implementation, interface 1018 may send and receive electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, or stored in storage device 1010, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments require more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating a proposed DCI according to embodiments and examples described herein.

Some embodiments pertain to Example 1 that includes a non-transitory machine-readable medium storing instructions, which when executed by one or more processing resources of a computer system cause the one or more processing resources to: determine whether to execute a non-containerized workload associated with a host application in a cloud or on a client computing system on which the host application is running; and after determining to execute the non-containerized workload on the client computing system: fetching a unit of execution in which the non-containerized workload is packaged; and causing the non-containerized workload to be run locally on the client computing system.

Example 2 includes the subject matter of Example 1, wherein determining whether to execute the non-containerized workload in the cloud or on the client computing system is performed by an offload recommendation engine represented in a form of a library consumed by the host application.

Example 3 includes the subject matter of Example 1 or 2, wherein determining whether to execute the non-containerized workload in the cloud or on the client computing system is based at least in part on a static configuration of the client computing system.

Example 4 includes the subject matter of any of Examples 1-3, wherein said determining whether to execute the non-containerized workload in the cloud or on the client computing system further comprises: obtaining information regarding a dynamic state of the client computing system; and evaluating an offload policy, defining conditions in which it is permissible to execute the non-containerized workload on the client computing system, against the static configuration and the dynamic state.

Example 5 includes the subject matter of any of Examples 1-4, wherein the offload policy is defined and hosted in the cloud.

Example 6 includes the subject matter of any of Examples 1-4, wherein the offload policy is built into the host application for the non-containerized workload.

Example 7 includes the subject matter of any of Examples 1-6, wherein the host application comprises a web application executing within a browser of the client computing system and interacts with the non-containerized workload.

Example 8 includes the subject matter of any of Examples 1-6, wherein the host application comprises a native application developed for a particular operating system of the client computing system and interacts with the non-containerized workload.

Example 9 includes the subject matter of any of Examples 1-8, wherein the unit of execution comprises a WebAssembly module or a machine-learning (ML) model.

Some embodiments pertain to Example 10 that includes a method comprising: determining whether to execute a non-containerized workload associated with a host application in a cloud or on a client computing system on which the host application is running; and after determining to execute the non-containerized workload on the client computing system: fetching a unit of execution in which the non-containerized workload is packaged; and causing the non-containerized workload to be run locally on the client computing system.

Example 11 includes the subject matter of Example 10, wherein said determining whether to execute the non-containerized workload in the cloud or on the client computing system is performed by an offload recommendation engine represented in a form of a library consumed by the host application.

Example 12 includes the subject matter of Examples 10 or 11, wherein said determining whether to execute the non-containerized workload in the cloud or on the client computing system is based at least in part on a static configuration of the client computing system.

Example 13 includes the subject matter of any of Examples 10-12, wherein said determining whether to execute the non-containerized workload in the cloud or on the client computing system further comprises: obtaining information regarding a dynamic state of the client computing system; and evaluating an offload policy, defining conditions in which it is permissible to execute the non-containerized workload on the client computing system, against the static configuration and the dynamic state.

Example 14 includes the subject matter of any of Examples 10-13, wherein the unit of execution comprises a WebAssembly module or a machine-learning (ML) model.

Example 15 includes the subject matter of any of Examples 10-14, further comprising: tracking a metric indicative of offload savings accrued by a vendor of the host application due to execution of the non-containerized workload on the client computing system; and distributing at least a portion of the cost savings to one or both of a subscriber of the host application and one or more third parties.

Example 16 includes the subject matter of any of Examples 10-15, wherein said distributing includes providing a statement credit to the subscriber.

Example 17 includes the subject matter of any of Examples 10-16, wherein said distributing includes causing a smart contract to disburse digital assets to one or both of the subscriber and the one or more third parties.

Example 18 includes the subject matter of any of Examples 10-17, wherein the metric comprises a number of application programming interface (API) calls invoked by the host application.

Some embodiments pertain to Example 19 that includes a method comprising: determining whether to execute a particular workload associated with a host application in a cloud or on a client computing system on which the host application is running; after a determination to execute the particular workload on the client computing system: fetching a unit of execution in which the particular workload is packaged; and causing the particular workload to be run locally on the client computing system; causing a metric indicative of usage of resources of the cloud by the host application over a particular timeframe to be tracked by a telemetry service; estimating based on the metric a cost savings over the particular timeframe accrued by a vendor of the host application; and distributing at least a portion of the cost savings to one or both of a subscriber of the host application and one or more third parties.

Example 20 includes the subject matter of Example 19, wherein the unit of execution comprises a non-containerized workload or a containerized workload.

Some embodiments pertain to Example 21 that includes an apparatus or a system that implements or performs a method of any of Examples 10-20.

Example 22 includes at least one machine-readable medium comprising a plurality of instructions, when executed on a computing device, implement or perform a method or realize an apparatus as described in any preceding Example.

Example 23 includes an apparatus or a system comprising means for performing a method as claimed in any of Examples 10-20.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by one or more processing resources of a computer system cause the one or more processing resources to:
determine whether to execute a non-containerized workload associated with a host application in a cloud or on a client computing system on which the host application is running; and
after determining to execute the non-containerized workload on the client computing system:
fetching a unit of execution in which the non-containerized workload is packaged; and
causing the non-containerized workload to be run locally on the client computing system.

2. The non-transitory machine-readable medium of claim 1, wherein determining whether to execute the non-containerized workload in the cloud or on the client computing system is performed by an offload recommendation engine represented in a form of a library consumed by the host application.

3. The non-transitory machine-readable medium of claim 1, wherein determining whether to execute the non-containerized workload in the cloud or on the client computing system is based at least in part on a static configuration of the client computing system.

4. The non-transitory machine-readable medium of claim 3, wherein said determining whether to execute the non-containerized workload in the cloud or on the client computing system further comprises:
obtaining information regarding a dynamic state of the client computing system; and
evaluating an offload policy, defining conditions in which it is permissible to execute the non-containerized workload on the client computing system, against the static configuration and the dynamic state.

5. The non-transitory machine-readable medium of claim 4, wherein the offload policy is defined and hosted in the cloud.

6. The non-transitory machine-readable medium of claim 4, wherein the offload policy is built into the host application for the non-containerized workload.

7. The non-transitory machine-readable medium of claim 1, wherein the host application comprises a web application executing within a browser of the client computing system and interacts with the non-containerized workload.

8. The non-transitory machine-readable medium of claim 1, wherein the host application comprises a native application developed for a particular operating system of the client computing system and interacts with the non-containerized workload.

9. The non-transitory machine-readable medium of claim 1, wherein the unit of execution comprises a WebAssembly module or a machine-learning (ML) model.

10. A method comprising:
determining whether to execute a non-containerized workload associated with a host application in a cloud or on a client computing system on which the host application is running; and
after determining to execute the non-containerized workload on the client computing system:
fetching a unit of execution in which the non-containerized workload is packaged; and
causing the non-containerized workload to be run locally on the client computing system.

11. The method of claim 10, wherein said determining whether to execute the non-containerized workload in the cloud or on the client computing system is performed by an offload recommendation engine represented in a form of a library consumed by the host application.

12. The method of claim 10, wherein said determining whether to execute the non-containerized workload in the cloud or on the client computing system is based at least in part on a static configuration of the client computing system.

13. The method of claim 12, wherein said determining whether to execute the non-containerized workload in the cloud or on the client computing system further comprises:
obtaining information regarding a dynamic state of the client computing system; and
evaluating an offload policy, defining conditions in which it is permissible to execute the non-containerized workload on the client computing system, against the static configuration and the dynamic state.

14. The method of claim 10, wherein the unit of execution comprises a WebAssembly module or a machine-learning (ML) model.

15. The method of claim 10, further comprising:
tracking a metric indicative of offload savings accrued by a vendor of the host application due to execution of the non-containerized workload on the client computing system; and
distributing at least a portion of the cost savings to one or both of a subscriber of the host application and one or more third parties.

16. The method of claim 10, wherein said distributing includes providing a statement credit to the subscriber.

17. The method of claim 10, wherein said distributing includes causing a smart contract to disburse digital assets to one or both of the subscriber and the one or more third parties.

18. The method of claim 10, wherein the metric comprises a number of application programming interface (API) calls invoked by the host application.

19. A method comprising:
determining whether to execute a particular workload associated with a host application in a cloud or on a client computing system on which the host application is running;
after a determination to execute the particular workload on the client computing system:
fetching a unit of execution in which the particular workload is packaged; and
causing the particular workload to be run locally on the client computing system;
causing a metric indicative of usage of resources of the cloud by the host application over a particular timeframe to be tracked by a telemetry service;
estimating based on the metric a cost savings over the particular timeframe accrued by a vendor of the host application; and
distributing at least a portion of the cost savings to one or both of a subscriber of the host application and one or more third parties.

20. The method of claim 19, wherein the unit of execution comprises a non-containerized workload or a containerized workload.
